(19) United States
(12) Patent Application Publication
(10) Pub. No.: US 2014/0339359 A1
(43) Pub. Date: Nov. 20, 2014

(54) Float for an aircraft

(71) Applicant: Piotr JEUTÉ, Warszawa (PL)

(72) Inventor: Piotr JEUTÉ, Warszawa (PL)

(21) Appl. No.: 14/277,858

(22) Filed: May 15, 2014

(30) Foreign Application Priority Data
May 15, 2013 (PL) PL403877

(51) Int. Cl. B64C 25/66

(52) U.S. Cl. CPC B64C 25/66
USPC 244/101

(57) ABSTRACT

A float for an aircraft, the float comprising: two buoyant side parts, a buoyant central part between the side parts, non-retractable main wheels, having their top part (a), that comprises at least 80% of the diameter (D) of the wheels, contained inside the float when viewed from the front, wherein the buoyant central part forms together with the buoyant side parts the furthermost frontal leading edge of the float and a trailing edge between the side parts, the trailing edge being offset from the rear end of the side parts towards the leading edge by a distance (b) which is at least one third of the length (L) of the side parts.

### TECHNICAL FIELD

The disclosure is related to a float for an aircraft, in particular, for a seaplane or for a flying boat.

### BACKGROUND

There are known various constructions of floats for seaplanes or for flying boats, the floats being equipped with wheels for landing on hard surfaces and for taking off from hard grounds. The wheels are typically retractable by a dedicated mechanism controlled by a pilot. There are also known constructions with non-retractable wheels, which cause resistance to water or air, significantly worsen aerodynamic and hydrodynamic properties, which significantly impedes the take off and landing on water, as well as it deteriorates flight excellence. Moreover, flying boats are typically equipped with a hull which is inimersable in water in its considerable part, in order to ensure stability and appropriate hydrodynamic profile. The hull must be sealed against water, in particular in the areas where the elements of the retractable undercarriage are attached, which increases the weight, complexity and the total costs of manufacture and maintenance of such constructions.

A US patent application US2006/0144999 discloses a wing mounted on a drag strut between floats. Such wing does not have any significant buoyancy. In addition, the floats are not equipped with wheels for landing and taking off from a hard ground. The wing between the floats is employed only to improve the aerodynamic characteristics during flight.

A U.S. Pat. No. 6,464,168 discloses a construction of a retractable undercarriage for aeroplanes. This construction enables retracting and extending wheels while landing and taking off from a hard ground. This construction increases the total weight of the aircraft. The undercarriage must be controlled while taking off and landing. Thus, there is a danger that a pilot may forget to activate the undercarriage when landing or taking off, which can be dangerous for the aircraft, the pilot and the passengers. A complex construction of the retractable undercarriage introduces additional, potentially unreliable elements to the design of the aircraft, that reduce the overall reliability and require periodic maintenance and repair.

A U.S. Pat. No. 3,159,364 discloses amphibian floats comprising means for retracting the floats with respect to non-retractable wheels. This allows to expose the wheels to the ground when landing on a hard surface and to land on water without the exposure of the wheels. This solution also introduces an additional, potentially unreliable lifting mechanism that increases the weight of the aircraft.

There is a need to provide a construction for a float that would be devoid of the above-mentioned problems, that would be simple and/or that would have improved aerodynamic and hydrodynamic properties. In addition, there is a need to provide an amphibian float that enables to land, including emergency landing, not only on water or on prepared runways, as it is the case for the existing amphibian structures typically equipped with wheels and components of undercarriage (that presently do not allow the use of other, including casual, landing and take-off areas). Therefore, there is a need to provide a construction of an amphibian float that allows landing not only on runways or water, but also on sand, snow, wetland, including grassy runways in autumn or winter periods, and/or (in the case emergency landings) on waterside reeds or on high grown cornfields—without risk of turnover or aircraft damage.

### SUMMARY

Particular embodiments presented herein are directed to a float for an aircraft, the float comprising: two buoyant side parts, a buoyant central part between the side parts, non-retractable main wheels, having their top part (a), that comprises at least 80% of the diameter (D) of the wheels, contained inside the float when viewed from the front, wherein the buoyant central part forms together with the buoyant side parts the furthermost frontal leading edge of the float and a trailing edge between the side parts, the trailing edge being offset from the rear end of the side parts towards the leading edge by a distance (b) which is at least one third of the length (L) of the side parts.

In some embodiments, the float comprises a lateral offset on the bottom surface.

In some embodiments, the lateral offset is located within the contour of the main wheels, when viewed from the side.

In some embodiments, the central part has an aerodynamic profile that is configured to generate an aerodynamic lift acting upwards.

In some embodiments, the centre of gravity of the float together with the aircraft is located behind the lateral offset as seen from the front, at a distance (c) that is 2% to 20% of the length (L) of the entire float.

Embodiments are also presented for a flying boat comprising the float as described above.

Embodiments are also presented for a seaplane comprising the float as described above.

In some embodiments of the seaplane, the displacement of the first part of the float, between the leading edge and the lateral offset, is at least 140% of MTOW of the seaplane, preferably at least 200% of MTOW of the seaplane, and wherein the displacement of the other part of the float is at least 50% of MTOW of the seaplane less than the displacement of the first part of the float.

It should be understood that the aforementioned embodiments are merely example implementations, and that claimed subject matter is not necessarily limited to any particular aspect of these example implementations.

### BRIEF DESCRIPTION OF FIGURES

The float for an aircraft is presented by means of example embodiments in a drawing, in which:

FIG. 1 shows a first embodiment of the float in an isometric top view.

FIG. 2 shows the first embodiment of the float in an isometric bottom view.

FIG. 3 shows a portion of the float including its main wheel in a side view.

FIG. 4 shows a longitudinal cross-section of the float at one-third of its width.

FIG. 5 shows the float and a seaplane in a side view, in a first embodiment.

FIG. 6 shows the second embodiment of the float for a flying boat in an isometric top view.

FIG. 7 shows the second embodiment of the float for a flying boat in an isometric bottom view.

### DESCRIPTION OF EMBODIMENTS

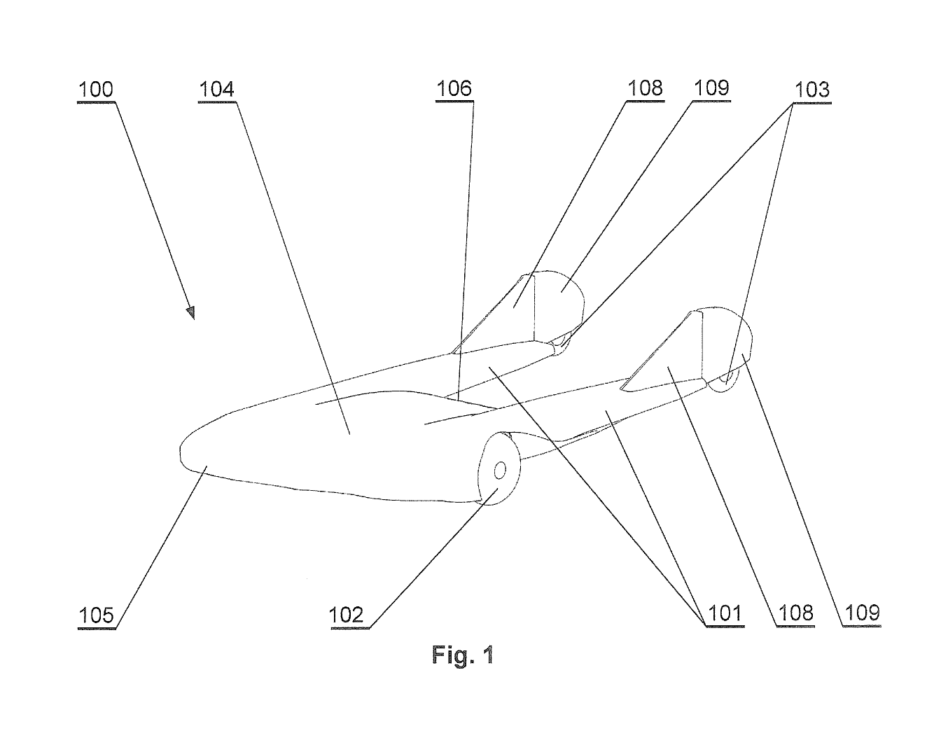

FIG. 1 shows the first embodiment of a float 100 in an isometric top view. It comprises two buoyant side parts 101 that run longitudinally in relation to a fuselage of a seaplane. Between the side parts 101 there is positioned a central buoyant part 104 that is integrally connected with the side parts 101. The central part 104 is positioned in relation to the side parts 101 such that they form together a single leading edge 105 of the float 100. The centre of the leading edge 105 is the furthest point put forward of the float 100. On both sides of the float 100. substantially in its central part, there are positioned main wheels 102, and rear wheels 103 are located substantially in the end segment of the side parts 101 for taking off from hard ground and for landing on hard ground. Both the main wheels 102 and the rear wheels 103 are not retractable, and their axles are fixed with respect to the floats and the fuselage. The rear wheels 103 are contained, in at least 60% of their diameter, in vertical stabilisers 109.

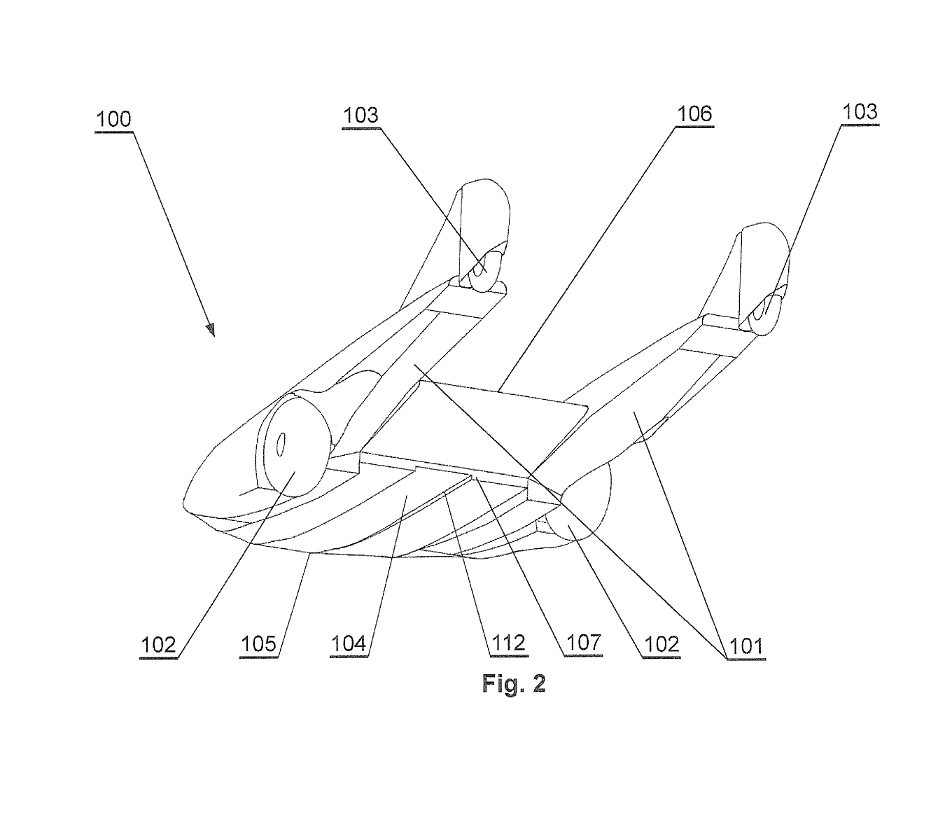

FIG. 2 shows the float 100 in an isometric bottom view. It shows a lateral offset 107, i.e. a redan. It is comprised in the contour of the main wheels 102, when viewed from the side of the float 100. The lateral offset 107 makes it easier to detach the float 100 from water, in particular while taking off from water table of a relatively smooth surface. FIG. 2 further shows longitudinal recesses 112. Preferably, the longitudinal recesses 112 are arranged so that the central point of the sliding surface of the central part 104 is higher than its adjacent portions of the sliding surfaces of the central part 104, which facilitates taking off from water surface while gaining speed.

When the float is applied to a seaplane, it is advantageous when the front part of the float 100, i.e. the part from the leading edge 105 to the lateral offset 107, has a displacement at least 140% of the weight of the whole craft in its flight configuration (MTOW=Maximum Take Off Weight), and more preferably at least 200% of MTOW. The reserve displacement in the front part of the float protects the seaplane against turnover during landing on water in cases when water surface is wavy or when a pilot makes a small fault during levelling out and during the float, both when the contact with water is too early with a high progressive speed (the levelling out is too late or the float is too short) and when it comes to the loss of aerodynamic lift just above water surface in the event of levelling out and floating too high. Landings on water, because of a difficulty of visual assessment of the distance to water surface, are burdened with a higher risk of errors in the optimum level of levelling out. As a result of a possible fault in the phase of levelling out or float during landing on water, a probable hit in water surface and the resistance of partially extended wheels will result in sudden braking of seaplane with the vector of gravity tilted firmly forward and with a force component within 1.3-1.4G. Displacement of the front part of the float at a level of at least 140% of MTOW will provide a minimum of safety at a very low wavy motion. The displacement at the level of at least 200% of MTOW will provide safe landing on more wavy water body. Therefore, it is possible to manufacture the float in different versions, depending on its purpose. In turn, the part located between the lateral offset 107 and the rear end of the side parts 101 has its displacement of at least 50% of MTOW less than the front part.

In addition, the lateral offset 107 and the axle of the main wheels 102 are always ahead the centre of gravity of the aircraft. Preferably, the centre of gravity of the float construction together with the aircraft is behind the lateral offset 107 as seen from the front at a distance of (c), wherein (c) is from 2% to 20% of the length (L) of the entire float. An aircraft fitted with the above-described float, while accelerating when taking off from water surface and with a sufficient aerodynamic force on the elevator, is able to enter into slide on the front part of the float 100 by reducing the exposure of the main wheels 102 from the front. This allows to reduce water resistance resulting from the presence of non-retractable wheels 102 and finally, faster and more reliable movement of the float in water. In turn, while landing on a hard ground, the construction of the float 100 allows to set it in relation to the ground such as to land directly on the main wheels 101 and on the rear wheels 103.

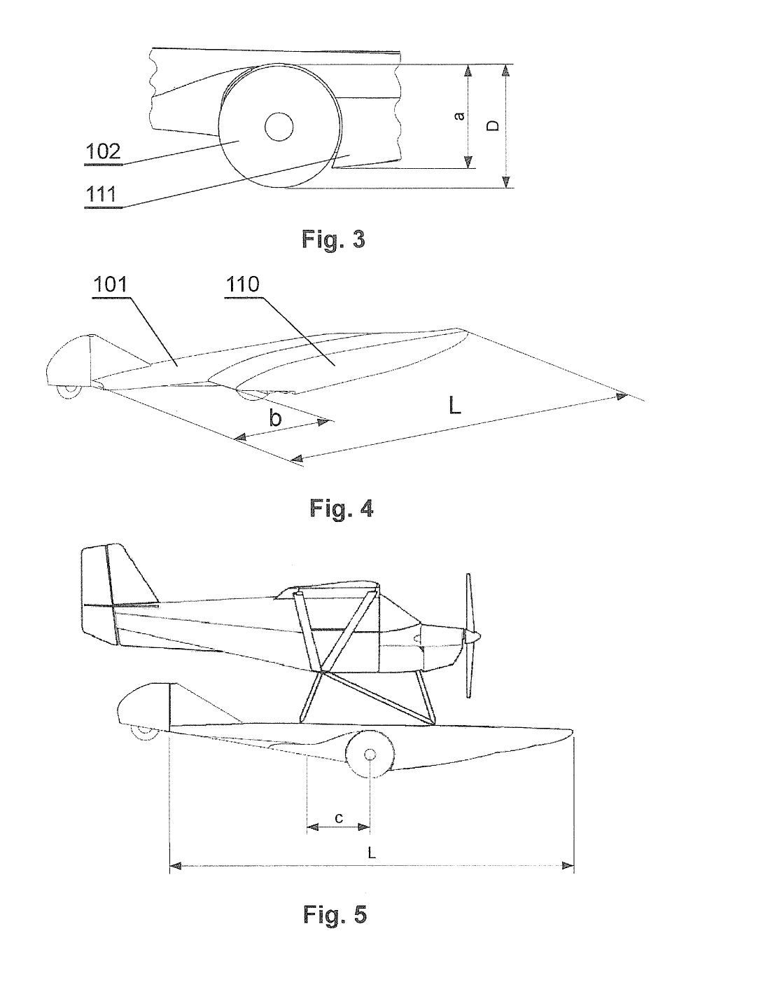

FIG. 3 shows a part of the float with the main wheels 102 in a side view. When viewed from the front, the main wheels 102 are contained in the top part (a) of their diameter (D) inside the float 100 when viewed from the front, wherein the top part (a) is at least 80% of the diameter (D). This has been achieved by shaping the side part 101 in front of the wheel as a deflector 111. As the position of the top plane the float 100 is generally horizontal, while sliding on water surface or during the flight, the exposure of the main wheels 102 from the front is less than while stationing on water or on the ground, or during the initial phase of accelerating on the ground when the position of the top plane of the float 100 is at an angle in relation to the horizontal plane, which is due to a smaller diameter of the rear wheels 103 and positioning of their axles above the axles of main wheels 102 with reference to the top plane of float 100. The placement of the axles of the rear wheels 103 above the axles of the main wheels 102 results in differences in float thickness in the location of the main wheels 102 and in the location of the rear wheels 103.

FIG. 4 presents a longitudinal profile of the float 100. The central part 104 of the float forms an aerodynamic profile 110 in its longitudinal cross-section both at one third and at two thirds of its width, which generates an aerodynamic lift that is directed upwards. Preferably, the chord of this profile is parallel, or slightly (about 5 degrees, or preferably 2 degrees) rising towards the front, in relation to the chord of the main aerofoil of the aircraft. In addition, a flow past of this profile between the side parts 101 (excluding possible deflector of the cab in a version for a flying boat) is not less in the top part than in the bottom part. This causes the aerodynamic lift to be directed upwards. The distance (b) between the trailing edge 106 and the rear end of the side parts 101 is at least one third of the length (L) of the side parts 101.

FIG. 5 shows a second embodiment of the float configured for a flying boat. Herein, the cabin 214 is contained in and integrated with the central part 204. Moreover, at the end of the side parts 201 of the float 200, there is located an elevator 213. The other parts 2xx of the float 200 are configured similarly to corresponding parts 1xx of the first embodiment.

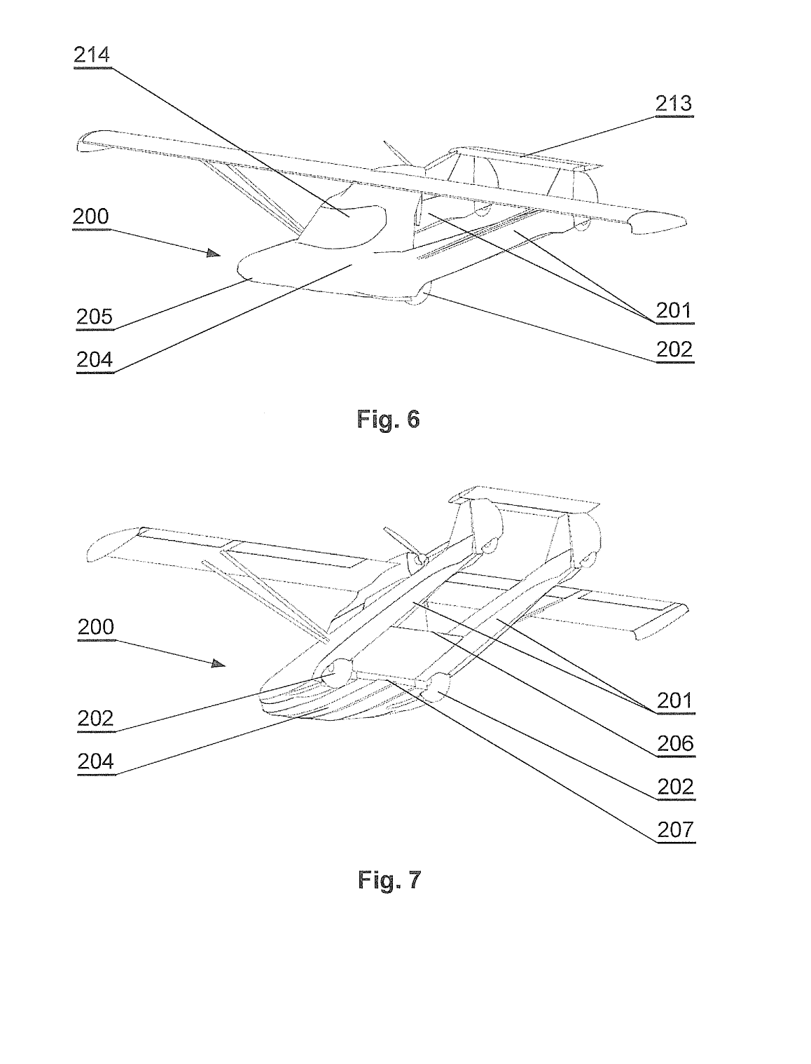

FIG. 6 shows the float 200 for a flying boat in a bottom view, wherein the trailing edge 206 and the lateral offset 207 are visible.

The float presented above can be used for unmanned seaplanes, for instance military seaplanes, where a pilot who is outside the aircraft has limited abilities to control that aircraft. Due to the versatile application of the float for landing many types of ground or water surfaces, it allows for more freedom in the use of unmanned aircraft, including taking off and landing under unforeseen conditions with unexpected nature of the ground or water. It prevents damage of costly aircraft, and, in particular, it enables its operation from practically any place, regardless whether a clean runway is available. It is particularly useful for heavier combat unmanned aircraft equipped with arms and, therefore, requiring (so far) the use of runways.

While the float presented herein has been depicted, described and defined with reference to particular preferred embodiments, such references and examples of implementation in the foregoing specification do not imply any limitations. It will, however, be evident that various modifications and changes may be made thereto without departing from the broader scope of the technical concept. The presented embodiments are of example only, and are not exhaustive of the scope of the technical concept presented herein.

Accordingly, the scope of protection is not limited to the embodiments described in the specification, but is only limited by the claims that follow.

I claim:

1. A float for an aircraft, the float comprising:
two buoyant side parts,
a buoyant central part between the side parts,
non-retractable main wheels, having their top part (a), that comprises at least 80% of the diameter (D) of the wheels, contained inside the float when viewed from the front,
wherein the buoyant central part forms together with the buoyant side parts the furthermost frontal leading edge of the float and a trailing edge between the side parts,
the trailing edge being offset from the rear end of the side parts towards the leading edge by a distance (b) which is at least one third of the length (L) of the side parts.

2. The float according to claim 1, comprising a lateral offset on the bottom surface.

3. The float according to claim 2, wherein the lateral offset is located within the contour of the main wheels, when viewed from the side.

4. The float according to claim 1, wherein the central part has an aerodynamic profile that is configured to generate an aerodynamic lift acting upwards.

5. The float according to claim 2, wherein the centre of gravity of the float together with the aircraft is located behind the lateral offset as seen from the front, at a distance (c) that is 2% to 20% of the length (L) of the entire float.

6. The float according to claim 3, wherein the centre of gravity of the float together with the aircraft is located behind the lateral offset as seen from the front, at a distance (c) that is 2% to 20% of the length (L) of the entire float.

7. A flying boat comprising the float according to claim 1.

8. A seaplane comprising the float according to claim 1.

9. The seaplane according to claim 8, wherein the displacement of the first part of the float, between the leading edge and the lateral offset, is at least 140% of MTOW of the seaplane, preferably at least 200% of MTOW of the seaplane, and wherein the displacement of the other part of the float is at least 50% of MTOW of the seaplane less than the displacement of the first part of the float.
